(19) United States
(12) Patent Application Publication
(10) Pub. No.: US 2012/0299738 A1
(43) Pub. Date: Nov. 29, 2012

(54) LIGHTING AND SMOKE DETECTOR DEVICE

(75) Inventor: Roger SELLAM, Fuveau (FR)

(73) Assignee: O'RIGHT, Fuveau (FR)

(21) Appl. No.: 13/477,706

(22) Filed: May 22, 2012

(30) Foreign Application Priority Data
May 23, 2011 (FR) 11/01593

(51) Int. Cl. G08B 17/10

(52) U.S. Cl. 340/628

(57) ABSTRACT

The invention relates to a device that comprises:
a base EMB provided with a connection cap DD;
a lighting module ME powered from the base EMB;
a link member OL between the base EMB and the lighting module ME;
a rechargeable battery arranged in the base EMB; and
a charger circuit arranged in the base EMB in order to charge the battery.

The device is remarkable in that it includes a smoke detector module arranged in the base EMB and powered by the battery, the link member OL being perforated so that the surrounding air flows within the base.

### BACKGROUND OF THE INVENTION

The present invention relates to a combined lighting and smoke detector device.

The field of the invention is that of safety in all types of premises, essentially in dwellings.

More particularly, it relates to safety means for combating fire. An essential component for this combat is a smoke detector. Such a component issues a warning on detecting smoke, the warning being issued by any suitable means, often by audible means.

Smoke detectors constitute means that are effective to such an extent that regulations concerning dwellings are tending to require general use thereof.

Nevertheless, they constitute fittings that need to be installed in premises, thereby requiring alteration work to be performed.

Furthermore, such a component is powered by an electric battery which raises problems when the battery runs out.

Document EP 1 881 261 is also known that teaches a warning system combined with a video camera. That system comprises:
a base provided with a connection cap;
a lighting module powered from the base;
a link member between the base and the lighting module;
a rechargeable battery arranged in the base; and
a charger circuit arranged in the base in order to charge the battery.

The lighting module is encumbered with several accessories:
a gas detector;
a video camera; and
human presence detectors.

It follows that the area of the lighting module that is available for lighting proper is greatly reduced since the accessories take the place of light-emitting diodes (LEDs).

### SUMMARY OF THE INVENTION

An object of the present invention is to thus to provide a device that enables smoke to be detected without harming the environment of the element in which it is incorporated. It does not require any alteration work and it presents improved safety since it is not powered by a non-rechargeable battery.

According to the invention, a device comprises:
a base provided with a connection cap;
a lighting module powered from the base;
a link member between the base and the lighting module;
a rechargeable battery arranged in the base; and
a charger circuit arranged in the base in order to charge the battery;

the device being remarkable in that it includes a smoke detector module arranged in the base and powered by the battery, the link member being perforated so that the surrounding air flows within the base.

Thus, the smoke detector module is incorporated in an electric light bulb. It is no longer an independent unit. In addition, it is powered by a rechargeable battery that is charged each time the bulb is switched on. There is therefore no longer any risk of power supply failure.

Preferably, the smoke detector module is provided with an audible alarm.

Advantageously, the smoke detector module is provided with warning means that activate the lighting module intermittently.

In a first option, the lighting module is bulb-shaped.

In a second option, the lighting module is in the shape of a tube that is terminated by another base.

Advantageously, the lighting module comprises light-emitting diodes.

As a result, the device includes a power supply circuit for powering the lighting module, this circuit being arranged in the base.

In a particular embodiment, the charger circuit is powered by the power supply circuit.

Optionally, the device includes a voltage-raising circuit arranged in the base, the voltage-raising circuit being interposed between the battery and the smoke detector module.

### BRIEF DESCRIPTION OF THE DRAWINGS:

The present invention appears below in greater detail with reference to the accompanying figures, in which:

FIG. 1 is a diagram of a first option in which the device is in the form of a bulb-shaped electric light bulb;

FIG. 2 is a block diagram showing the operation of the device with the distribution of its various elements within the bulb;

FIG. 3 is a block diagram showing the operation of the device adapted to the situation in which the lighting module has a plurality of LEDs; and

FIG. 4 is a diagram of a second option in which the device is in the form of a lighting tube.

Elements that are present in two or more figures are given the same references in each of them.

### DETAILED DESCRIPTION OF THE INVENTION:

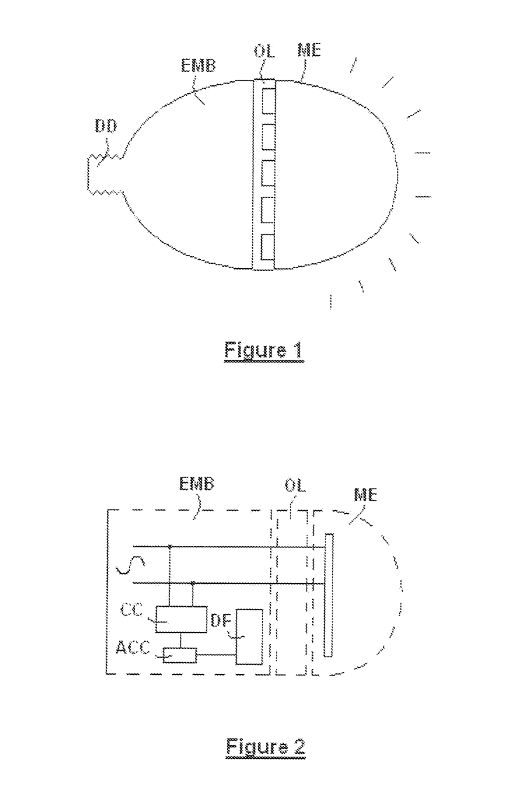

With reference to FIG. 1, the device is in the form of a bulb-shaped electric light bulb. It comprises a base EMB provided with a cap DD for electrical connection. The base EMB carries a dome-shaped lighting module ME. Between the base EMB and the lighting module ME there is a link member OL that is perforated so as to allow air to pass through it. The link member OL is in the form of a ring and it is secured to the base EMB and to the lighting module ME by any known means, e.g. adhesive.

With reference to FIG. 2, the base EMB is fastened to a charger circuit CC that is powered with alternating current from the mains via the cap. The charger circuit CC is designed to charge a rechargeable battery ACC.

Still within the base EMB, there is a smoke detector module DF that is powered by the battery ACC. This smoke detector module DF incorporates warning means, e.g. an audible alarm. It is in contact with the surrounding air as a result of the link member OL being perforated. Thus, if there is any smoke in the vicinity of the device, it reaches the smoke detector module DF.

The warning means may also activate the lighting module intermittently so that if smoke is detected the light can be seen to be flashing.

In a first embodiment, the lighting module is an incandescent lamp having its filament powered by two conductors that are connected to the cap DD. These two conductors pass through the link member OL.

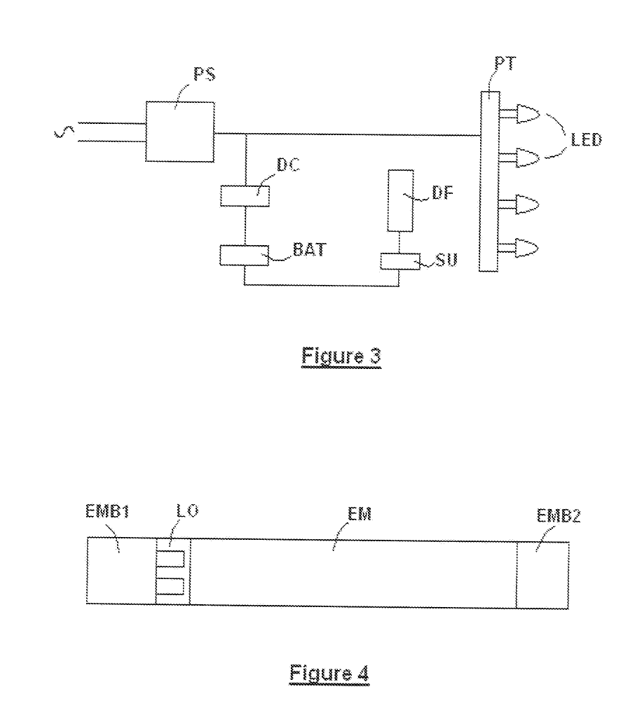

With reference to FIG. 3, in a second embodiment, the lighting module ME incorporates a plate PT having a plurality of LEDs mounted thereon. For this purpose, a power supply circuit PS is arranged in the base EMB. The power supply circuit PS receives mains voltage via the cap and it delivers a direct current lighting voltage for powering the LEDs. By way of example, the lighting voltage may be 30 volts (V) while the alternating mains voltage is 220 V.

Provision may be made in this embodiment for the warning means to act in two different ways:
if mains voltage is present, it causes all of the LEDs to be switched on intermittently; and
if mains voltage is absent, it switches on only a fraction of the LEDs intermittently, using the battery BAT and a circuit that is not shown.

LEDs give off a considerable amount of heat. They are located close to the battery BAT, which means that it must be capable of withstanding a relatively high temperature. Thus, it is preferable to select a high temperature nickel-metal-hydride rechargeable battery having a nominal voltage of 1.2 V.

Furthermore, a standard smoke detector is powered with 9 V.

Thus, a charger circuit DC is powered from the power supply circuit PS in order to charge the battery BAT. A voltage-raising circuit SU is powered by the battery (1.2 V) in order to raise the voltage to the operating voltage (9 V) of the smoke detector module DF.

As explained above, the present invention applies when the body of the device is in the form of a bulb-shaped light bulb.

With reference to FIG. 4, the invention also applies when the lighting means EM are in the form of a tube.

The tube EM is arranged between a first base EMB1 and a second base EMB2. The device is powered electrically between these two bases EMB1 and EMB2.

A link member LO, perforated as in the previous embodiment, is interposed between the first base EMB1 and the tube EM, while the second base EMB2 is connected directly to the tube EM.

The electronic components needed for the operation of the smoke detector module DF and also said module itself are arranged in the first base EMB1.

If a power supply circuit is required for the lighting module EM, it may be arranged equally well in the first base EMB1 or in the second base EMB2.

In the present invention, the term “link member” should be understood very broadly. It is constituted by any element having the function of putting the smoke detector module into contact with the surrounding air.

The embodiments of the invention that are described above have been selected because of their concrete nature. Nevertheless, it is not possible to list exhaustively all possible embodiments covered by the invention. Specifically, any of the means described may be replaced by equivalent means without going beyond the ambit of the present invention.

1. A device comprising:
a base (EMB, EMB1) provided with a connection cap (DD);
a lighting module (ME, EM) powered from said base (EMB, EMB1);
a link member (OL, LO) between said base (EMB, EMB1) and said lighting module (ME, EM);
a rechargeable battery (ACC, BAT) arranged in said base (EMB, EMB1); and
a charger circuit (CC, DC) arranged in said base (EMB, EMB1) in order to charge said battery (ACC, BAT);
the device being characterized in that it includes a smoke detector module (DF) arranged in said base (EMB, EMB1) and powered by said battery (ACC, BAT), said link member (OL, LO) being perforated so that the surrounding air flows within said base.

2. A device according to claim 1, characterized in that said smoke detector module (DF) is provided with an audible alarm.

3. A device according to claim 1, characterized in that said smoke detector module (DF) is provided with warning means that activate said lighting module (ME, EM) intermittently.

4. A device according to claim 1, characterized in that said lighting module (ME) is bulb-shaped.

5. A device according to claim 1, characterized in that said lighting module (EM) is in the shape of a tube that is terminated by another base (EMB2).

6. A device according to claim 1, characterized in that said lighting module (ME) comprises light-emitting diodes (LEDs).

7. A device according to claim 6, characterized in that it includes a power supply circuit (PS) for powering said lighting module (ME), this circuit being arranged in said base (EMB, EMB1, EMB2).

8. A device according to claim 7, characterized in that said charger circuit (DC) is powered by said power supply circuit (PS).

9. A device according to claim 1, characterized in that it includes a voltage-raising circuit (SU) arranged in said base (EMB, EMB1), the voltage-raising circuit being interposed between said battery (BAT) and said smoke detector module (DF).
